(19) United States
(12) Patent Application Publication
(10) Pub. No.: US 2016/0194132 A1
(43) Pub. Date: Jul. 7, 2016

(54) PLASTIC-CONTAINING FOODSTUFF CONTAINERS USING IRREVERSIBLE THERMOCHROMIC MATERIAL TO INDICATE PAST EXPOSURE TO ELEVATED TEMPERATURES

(71) Applicants: Lara L. Davidson, Austin, TX (US); Ryan S. Davidson, Austin, TX (US)

(72) Inventors: Lara L. Davidson, Austin, TX (US); Ryan S. Davidson, Austin, TX (US)

(21) Appl. No.: 14/588,570

(22) Filed: Jan. 2, 2015

(51) Int. Cl. B65D 79/02; G01N 21/25; B07C 5/342; G01K 11/12

(52) U.S. Cl. CPC B65D 79/02; G01K 11/12; G01N 21/25; B07C 5/3422

(57) ABSTRACT

An article includes a foodstuff container comprising a plastic, and a container component containing an irreversible thermochromic material configured to undergo a permanent color change responsive to exposure to temperatures above a threshold range. A system includes an optical scanner to capture imagery of a batch of foodstuff containers, at least one foodstuff container of the batch comprising an irreversible thermochromic material configured to permanently undergo a color change after exposure to temperatures above a threshold temperature range. The system also includes an image processing system to analyze the imagery to determine whether a foodstuff container of the batch has thermochromic material that has permanently undergone the color change. The system further includes a flow control system to prevent further distribution of a foodstuff container of the batch responsive to the image processing system determining that the foodstuff container has thermochromic material that has permanently undergone the color change.

### BACKGROUND

1. Field of the Disclosure

The present disclosure relates generally to plastic containers for consumables and, more particularly, to detection of exposure of plastic containers to excess heat.

2. Description of the Related Art

From bottles to liners of metal cans, plastics frequently are used in containers holding food or liquids for consumption by humans or other animals. Such plastics often leach potentially toxic chemicals, such as bisphenol A (BPA) and phthalates, into the contents they contain. The rate at which plastics leach such chemicals is related to the temperature of the plastic, and thus the exposure of plastic-containing foodstuff containers to elevated temperatures places consumers at an increased risk of inadvertently and unknowingly ingesting foodstuffs contaminated with potentially harmful chemicals. Moreover, at such elevated temperatures, bacterial growth is stimulated, and thus stimulating bacterial toxin production, thereby also increasing the likelihood of further contamination.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 is a diagram illustrating a foodstuff container utilizing an irreversible thermochromic material to indicate past exposure to excessive temperatures in accordance with some embodiments.

FIG. 2 is a diagram illustrating a foodstuff container utilizing labeling with irreversible thermochromic material to indicate past exposure to excessive temperatures in accordance with some embodiments.

FIG. 3 is a diagram illustrating an automated inspection system for inspecting foodstuff containers for indicia of thermochromic material coloration changes signifying past exposure to excessive temperatures in accordance with some embodiments.

### DETAILED DESCRIPTION

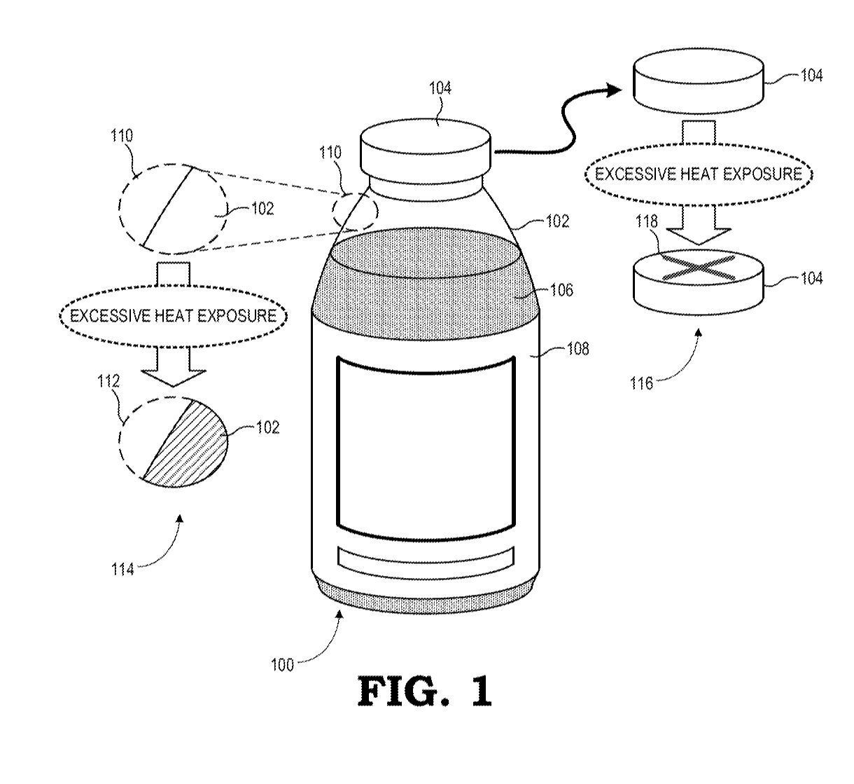

As the leach rate of potentially harmful chemicals from plastics in foodstuff containers increases with temperature, foodstuff containers exposed to excessive temperatures (commonly referred to in the industry as “temperature abuse”) may be particularly likely to contaminate the foodstuffs contained therein. The exposure to excessive temperatures may be reflected by an elevated ambient temperature, or by the incidence of ultraviolet (UV) light on the foodstuff container, which in turn increases the temperature of the foodstuff container and the foodstuffs contained therein. Accordingly, FIGS. 1-3 illustrate example articles and techniques for detecting the exposure of foodstuff containers to excessive temperatures (either via ambient temperature or UV light exposure) so as to identify potentially contaminated foodstuffs. In at least one embodiment, a foodstuff container that incorporates plastic in contact with foodstuff utilizes a container component that incorporates an irreversible thermochromic material that is configured to permanently change color in response to exposure to heat above a threshold temperature or threshold temperature range. This irreversible thermochromic material may be composed of a pigment that is suspended in at least a portion of the plastic material of the foodstuff container, an ink printed directly on a surface of the plastic material or printed on a label that is affixed to the foodstuff container, and the like. The thermochromic material may be selected to exhibit the permanent change in coloration at a selected temperature, such as a temperature or temperature range that is above the temperatures that the foodstuff containers are usually exposed to during storage or transportation to their final distribution point. This temperature range thus may reflect a maximum customary temperature for at least one of: storing the foodstuff container prior to transfer to a consumer; and transporting the foodstuff container prior to final transfer to a consumer.

Conventional use of thermochromic materials exhibiting temporary color changes permits an observer to note only whether the object having such materials currently is at a particular temperature (e.g., as used in some drink cans or bottles to let the consumer know that the drink has sufficiently chilled). However, this does not allow an observer to effectively evaluate the history of temperature exposures of the object having the temporary thermochromic materials. In contrast, the use of irreversible thermochromic material as taught therein results in exhibition of a permanent color change when the foodstuff container is exposed to excessive temperatures. As such, prior exposure of the foodstuff container to excessive temperatures (and thus likely exposure to a significant chemical leach rate) at some earlier point in its handling, storage or transport may be detected long after the ambient temperature of the foodstuff container has returned to a non-elevated temperature. That is, once potentially contaminated due to excessive temperature exposure, the foodstuff container may be permanently identified as such via the irreversible thermochromic material. This allows a manufacturer, distributor, supplier or seller to prevent further distribution of the potentially contaminated foodstuffs, as well as enabling a consumer to avoid purchase of the foodstuffs or the consumption of the foodstuffs contained therein.

For ease of illustration, example embodiments are described in the context of a plastic bottle containing drinking water or other liquid. However, the techniques described herein are not limited to this context, but instead may be applied to any of a variety of foodstuff containers utilizing plastic material that is in contact with a foodstuff (that is, a fluids or food intended for consumption by humans or other animals), such as the aforementioned bottle or other plastic container, plastic-lined paper boxes, plastic-lined metal cans, plastic zipper storage bags, and the like.

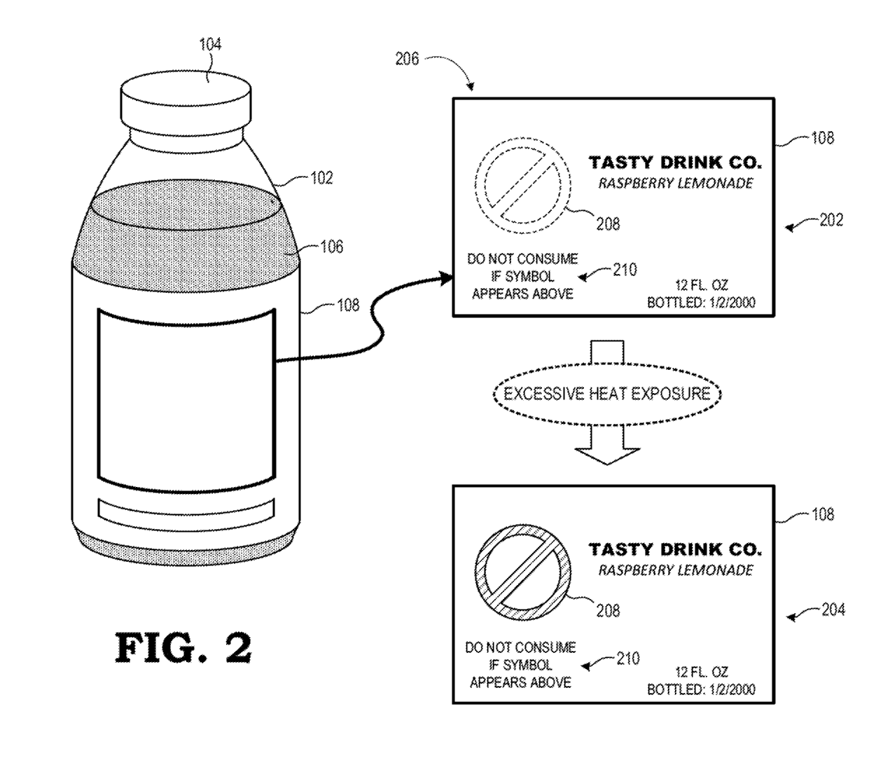

FIGS. 1 and 2 illustrate examples of a foodstuff container 100 utilizing irreversible thermochromic material to permanently identify past exposure of plastic contained therein to excessive temperatures in accordance with some embodiments of the present disclosure. In the depicted example, the foodstuff container 100 comprises a bottle body 102 and bottle lid 104. The bottle body 102 is composed substantially of plastic and is used to contain a foodstuff 106, such as drinking water or other drinkable fluid. The bottle lid 104 may be composed of one or a combination of materials, such as plastic, metal, and the like. The foodstuff container 100 further includes one or more labels 108 affixed to an external surface of the bottle body 102, such as being affixed to the side surface as shown in FIGS. 1 and 2.

The foodstuff container 100 has a container component that incorporates an irreversible thermochromic material that is configured to permanently change color (or otherwise change in appearance) responsive to exposure to temperatures above a corresponding temperature or, because many commonly available irreversible thermochromic materials exhibit hysteresis in that the color change progresses over a range of temperatures, to exposure to heat within or above a threshold temperature range. Thus, as used herein, a threshold temperature range may include a single temperature or a multitude of temperatures.

The irreversible thermochromic materials can include, for example, leuco dyes in the form of a thermochromic ink for printing onto a surface or otherwise applying to a surface, pigments in the form of a powder, slurry, or concentrate for use as a colloid or other suspension within plastic material of the foodstuff container 100, and the like. The color of the thermochromic material prior to exposure to excessive heat is referred to herein as the “original color” and the color of the thermochromic material after exposure to excessive heat is referred to herein as the “indicator color” in reference to its use in indicating that foodstuff 106 in the foodstuff container 100 is potentially contaminated by increase chemical leaching from the plastic of the foodstuff container 100 or other deleterious effects due to the elevated temperatures to which the foodstuff container 100 was exposed.

Commercially-available examples of irreversible thermochromic materials include the Black K60-NH, MB50Y-NH, MB60-NH, and Magenta K65-NH irreversible thermochromic ink products available from LCR Hallcrest of Glenview, Ill., the OliKrom@TOne range of irreversible thermochromic pigments available from OliKrom of Pessac, France, and the range of irreversible thermochromic pigments available from Brancher of Tremblay, France. Each of these commercially available product lines have inks or pigments that initiate permanent color change starting at 50-60 Celsius (122-140 degrees Fahrenheit), which is a suitable threshold temperature range as these temperatures are slightly above the temperatures that foodstuff containers ideally are exposed to during storage, transport, or handling, as well as representing elevated temperatures that may be reached by, for example, a bottle left in a car on a hot summer day. However, thermochromic materials with higher or lower threshold temperature ranges may be utilized. To illustrate, for foodstuff containers that often are mistakenly used as containers during microwave heating, a thermochromic material exhibiting permanent color change starting at 65-70 Celsius may be well-suited for use in permanently indicating that the foodstuff container has been overheated during the microwave process. Moreover, in some embodiments, combinations of different irreversible thermochromatic materials may be used so as to indicate a graduation of excessive temperature exposures.

In the examples depicted in FIG. 1, the container component implementing the irreversible thermochromic material can comprise a portion or the entirety of the plastic material that is in contact with the foodstuff 106. As illustrated by detail views 110 and 112 of sequence 114, the container component implementing the irreversible thermochromic material can comprise a portion or the entirety of the bottle body 102 such that the thermochromic material is embedded or otherwise suspended into the plastic material comprising the bottle body 102 or such that the thermochromic material is printed on, or otherwise applied to a surface (e.g., the external surface) of the plastic material forming the bottle body 102. Thus, as shown by detail view 110, so long as the foodstuff container 100 has not been exposed to heat above the threshold temperature range of the thermochromic material suspended therein or printed thereon, the plastic material of the bottle body 102 remains substantially transparent or remains primarily colored with the original color of the thermochromic material (or a color representing the blend of the original color and the color of the plastic material), depending on the concentration of the thermochromic material suspended therein or printed thereon. However, as illustrated by detail view 112, once the foodstuff container 100 has been exposed to excessive heat, the thermochromic material permanently changes color to the indicator color, and thus the bottle body 102 takes on this indicator color, or a color representing a blend of the indicator color and the color of the plastic material of the bottle body 102.

As another example, as depicted by sequence 116, the bottle lid 104 may be used as the container component that is used to indicate past exposure to excessive heat. In this embodiment, irreversible thermochromic material may be printed onto the top surface of the bottle cap or suspended in the plastic material of the bottle lid 104 itself. Thus, without exposure to excessive heat, the bottle lid 104 does not exhibit the indicator color of the thermochromic material. However, after exposure to excessive heat, the thermochromic material permanently changes color to the indicator color, which may manifest as, for example, a particular pattern 118 on the bottle lid 104, such as the depicted “X”, in the event that the thermochromic ink was printed on the bottle lid 104 in that pattern) or by changing the color of the plastic material of bottle lid 104 in the event that the thermochromic material was incorporated into the plastic material of the bottle lid 104.

As depicted in FIG. 2, the label 108 also may be used as the container component instead of, or in addition to, the use of the plastic of the body of the foodstuff container 100. The use of the label 108 for implementing the irreversible thermochromic material may be particularly well suited when the foodstuff container 100 is a plastic-lined paper box or plastic-lined metal can, when the plastic material of the body of the foodstuff container 100 is colored in a manner that would interfere with detection of the color change of the thermochromic material, or when the cost or complexity of implementing sufficient thermochromic material in the plastic material of the body is greater than the cost or complexity of printing the thermochromic material on the label 108.

As shown by label view 202 of sequence 206, during the manufacturing process irreversible thermochromic ink may be printed on the label 108 using a printing process suitable to the ink so as to form a pattern 208 in a corresponding region of the label 108. In the illustrated embodiment, the background of the label 108 is printed using a conventional ink having a color closely matching the original color of the thermochromic ink so that the pattern 208 is not readily discernable under casual inspection. However, as shown by label view 204, after exposure to excessive heat, the thermochromic ink permanently changes colors to its indicator color, and thus rendering the pattern 208 visible due to the contrast between the indicator color and the background color of the label 108.

Although examples are described whereby a symbol or other pattern are made visible by the coloration change of the thermochromic material due to excessive heat exposure, it will be appreciated that in other implementations the symbol or other pattern may become effectively “invisible” to casual inspection by the changed color of the thermochromic material due to excessive heat exposure. To illustrate, the label 108 may implement a symbol printed in irreversible thermochromic ink that has an original color that contrasts sharply with a background color of the label 108, but which is configured to change to a color that substantially matches the background color of the label 108, such that the symbol is visible when the thermochromic material displays its original color, and is rendered essentially invisible when the thermochromic material changes to its indicator material after being exposed to temperatures at or above the threshold temperature range.

Further, text, symbols, or other information may be printed on the label 108 to guide the interpretation of the pattern 208. To illustrate, text 210 may be printed on the label 108 to inform a reader that if a symbol (e.g., the visible form of the printed pattern 208) appears above the text 210 on the label, then the reader is not to consume the contents of the foodstuff container 100, or vice versa. Such interpretation information likewise may be printed directly on an external surface of the body of the foodstuff container 100. To illustrate, in an implementation of the foodstuff container as a plastic-lined paper box, the thermochromic ink pattern and interpretation instructions may be directly printed on one or more external paper surfaces of the box. Similarly, in an implementation of the foodstuff container as a plastic zipper storage bag, the thermochromic material may be suspended in the plastic material of the zipper storage bag or printed on a surface of the zipper storage bag, and interpretation instructions may be printed on a surface of the zipper storage bag.

As shown by the example implementations of FIGS. 1 and 2, the use of one or more components of the foodstuff container 100 to incorporate irreversible thermochromic material reactive to excessive temperature exposure permits the foodstuff container 100 to provide a permanent visual indicator that the foodstuff container 100 has been exposed to excessive temperatures at some point, and thus the foodstuffs contained therein have an increased likelihood of contamination from chemicals leaching from the plastic of the foodstuff container 100. Food items having a foodstuff container 100 displaying such indicia then may be prevented for further distribution, such as by refusing delivery or acceptance of the potentially-contaminated food items, by destroying or discarding the potentially-contaminated food items, and the like. This inspection may be performed manually, such as by an end consumer is considering purchasing the foodstuff item from a store, by a store employee upon receiving a shipment of foodstuff items, and the like. However, in other embodiments, this visual inspection may be performed via an automated process, as described below.

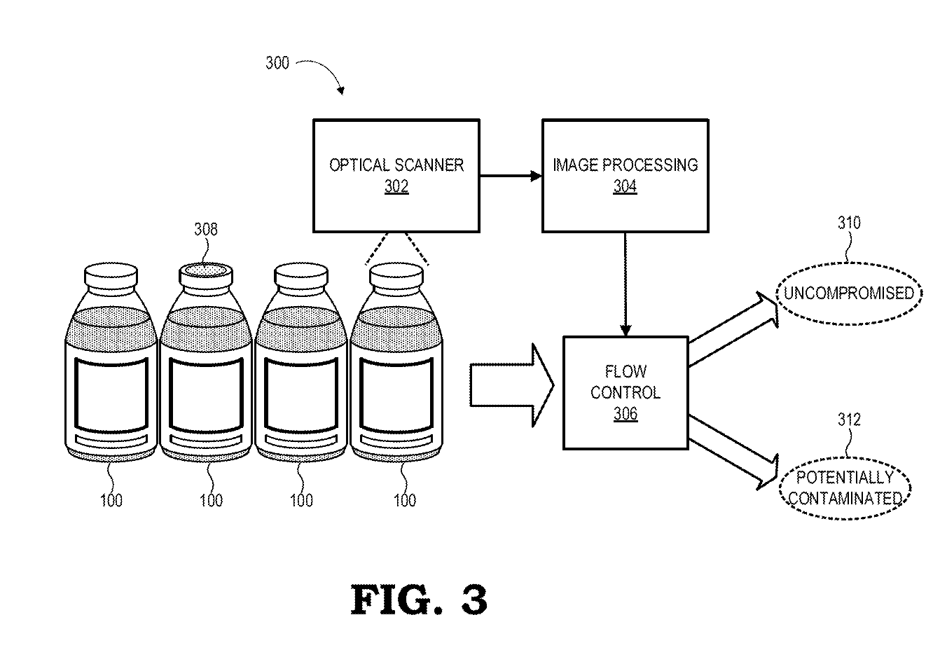

FIG. 3 illustrates an automated system 300 for inspecting foodstuff containers for evidence or other indicia of exposure to excessive temperatures in accordance with at least one embodiment of the present disclosure. The automated system 300 may be implemented in the initial manufacturing process for the foodstuff items. Alternatively, the automated system 300 may be implemented at some point in the distribution chain for the foodstuff items, such as at a trucking distribution hub or in the storeroom of a grocery store. In the depicted example, the system 300 comprises an optical scanner 302 coupled to an image processing system 304, which in turn is coupled to a flow control system 306. The image processing system 304 and flow control system 306 may be implemented as, for example, computing systems executing software in the form of executable instructions stored on a non-transitory computer readable medium (e.g., system memory, a hard drive, an optical disc, etc.), whereby the instructions, when executed, manipulate the computing system to perform the functionality described herein.

In operation, imagery of a batch of one or more foodstuff containers 100 is captured by the optical scanner 302 and provided to the image processing system 304. The optical scanner 302 may capture a separate image of each foodstuff container 100 (e.g., such as by processing each foodstuff container 100 in sequence as shown in FIG. 3) or the optical scanner 302 may capture multiple foodstuff containers 100 (e.g., a subset of the batch or the entire batch) in a single image. The optical scanner 302 is oriented relative to the foodstuff containers 100 being inspected such that the imagery captures the portion of the foodstuff containers 100 implementing the irreversible thermochromic material. In the example depicted in FIG. 3, the bottle lids 104 are implemented as the container component that has the irreversible thermochromic material, and thus the optical scanner 302 may capture imagery of the tops of the bottle lids 104.

The imagery is provided to the image processing system 304, which analyzes the imagery to determine whether any of the foodstuff containers 100 are displaying a pattern or other visual indication that the irreversible thermochromic material has changed color from the original color to the indicator color, and thus has been exposed to excessive temperatures. In the example of FIG. 3, this may be identified by detecting in the imagery a particular pattern (e.g., an “X” as shown in FIG. 1) or detecting the indicator color in the imagery. Further, the image analysis may identify the particular foodstuff container 100 or containers 100 exhibiting the detected indicia.

The image processing system 304 provides the results of its analysis to the flow control system 306. In response to detecting indicia of excessive heat exposure in the batch, the flow control system 306 may take various actions within the processing machinery of the system 300 to prevent further distribution of the potentially contaminated foodstuff items. To illustrate, the processing path for the foodstuff containers 100 may include one processing path 310 for foodstuff containers 100 identified as uncompromised as a result of the inspection process, and a separate processing path 312 for foodstuff containers 100 identified as potentially contaminated as a result of the inspection process. The processing path 312 may be configured so as to prevent any further distribution of potentially contaminated foodstuff containers 100, such as by mechanically routing the potentially contaminated foodstuff containers 100 to a section where they ultimately will be destroyed or discarded. In some embodiments, only the potentially contaminated foodstuff containers 100 of the batch are rerouted for discarding or destruction, if the image processing system 304 is capable of specifically identifying a foodstuff container 100 as potentially contaminated from the captured imagery. To illustrate, in the example of FIG. 3, the third foodstuff container 100 has a bottle lid 104 that exhibits the indicator color due to the permanent color change of the thermochromic material contained therein, and thus the flow control system 306 may reroute the third foodstuff container 100 to a station that will destroy or discard the third foodstuff container 100. Alternatively, the entire batch may be rerouted for discarding or destruction if the image processing system 304 cannot specifically identify which particular foodstuff containers 100 of the batch are potentially contaminated, or if the presence of a statistically significant percentage of the foodstuff containers 100 of the batch are exhibiting indicia of excessive temperature exposure, thereby supporting the conclusion that the entire batch was likely exposed to excessive heat.

Regardless of whether the inspection is performed manually or with the automated system 300 of FIG. 3, the use of one or more container components incorporating thermochromic material permits the rapid identification of foodstuff containers that have been exposed to excessive heat and thus have likely leached an unacceptable level of potentially harmful chemicals into the foodstuffs contained therein. Moreover, because irreversible thermochromic material is utilized, potentially compromised foodstuffs may be identified long after the excessive heat exposure has concluded. As such, a manufacturer, distributor, supplier, seller, or consumer may more easily rest assured that a foodstuff container not exhibiting indicia of excessive heat exposure via the irreversible thermochromic ink is more likely to be free of chemical contaminants than a foodstuff item lacking such permanent visible indicia.

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed is:

1. An article comprising:
a foodstuff container comprising a plastic; and
a container component containing an irreversible thermochromic material configured to undergo a permanent color change responsive to exposure to temperatures above a threshold range.

2. The article of claim 1, wherein:
the container component comprises a label affixed to a surface of the foodstuff container.

3. The article of claim 2, wherein:
the irreversible thermochromic material comprises thermochromic ink printed at a region of the label; and
the label further comprises printed information regarding interpretation of a coloration of the region.

4. The article of claim 1, wherein:
the foodstuff container comprises a bottle; and
the container component comprises a bottle lid, wherein the irreversible thermochromic material is at least one of: a thermochromic pigment suspended in a material of the bottle lid; and a thermochromic ink printed at a surface of the bottle lid.

5. The article of claim 1, wherein the container component comprises a plastic material of the foodstuff container.

6. The article of claim 5, wherein the irreversible thermochromic material is at least one of: suspended in the plastic material; and printed on a surface of the plastic material.

7. The article of claim 1, wherein the threshold range represents a maximum customary temperature for at least one of: storing the foodstuff container prior to transfer to a consumer; and transporting the foodstuff container prior to final transfer to a consumer.

8. The article of claim 1, wherein the foodstuff container comprises one selected from a group consisting of: a bottle; a plastic box; a plastic-lined paper box; a plastic lined metal can; and a plastic zipper storage bag.

9. A bottle comprising:
a plastic bottle body to contain a foodstuff; and
a bottle lid comprising an irreversible thermochromic material configured to permanently undergo a color change after exposure to heat above a threshold temperature range.

10. The bottle of claim 9, wherein the irreversible thermochromic material is at least one of: an irreversible thermochromic material suspended in a plastic material of the bottle lid; and a thermochromic ink printed at a surface of the bottle lid.

11. A system comprising:
an optical scanner to capture imagery of a batch of foodstuff containers, at least one foodstuff container of the batch comprising an irreversible thermochromic material configured to permanently undergo a color change after exposure to temperatures above a threshold temperature range;
an image processing system coupled to the optical scanner, the image processing system to analyze the imagery to determine whether a foodstuff container of the batch has thermochromic material that has permanently undergone the color change; and
a flow control system coupled to the image processing system, the flow control system to prevent further distribution of a foodstuff container of the batch responsive to the image processing system determining that the foodstuff container has thermochromic material that has permanently undergone the color change.

12. The system of claim 11, wherein:
the irreversible thermochromic material is disposed at a label of the foodstuff container; and
the optical scanner captures imagery of the label of the foodstuff container.

13. The system of claim 11, wherein:
the irreversible thermochromic material is disposed at a region of plastic material of a body of the foodstuff container; and
the optical scanner captures imagery of the region of plastic material of the body of the foodstuff container.

14. The system of claim 11, wherein:
the irreversible thermochromic material is disposed at a lid of the foodstuff container; and
the optical scanner captures imagery of the lid of the foodstuff container.
